(19) United States
(12) Patent Application Publication
(10) Pub. No.: US 2005/0252910 A1
(43) Pub. Date: Nov. 17, 2005

(54) Electrical heating cable

(75) Inventor: Jason Daniel Harold O'Connor, Glossop (GB)

Correspondence Address: CONLEY ROSE, P.C., P. O. BOX 3267, HOUSTON, TX, 77253-3267, US

(73) Assignee: Heat Trace Limited, Stockport (GB)

(21) Appl. No.: 10/521,835

(22) PCT Filed: Jul. 17, 2003
(86) PCT No.: PCT/GB03/03120

§ 371 Date: Mar. 17, 2005

(30) Foreign Application Priority Data
Jul. 20, 2002 (GB) 0216932.4

(51) Int. Cl. H05B 1/02

(52) U.S. Cl. 219/544; 219/549; 219/505

(57) ABSTRACT

An electrical heating cable of the type in which two power supply conductors extend along the length of the cable and the heating element extends along the length of the cable and between the two conductors, connected in parallel between the conductors. One or both of the conductors is encased in the sheath of material which has a positive temperature coefficient and the heating element is in electrical contact with the outer surface of the sheath. As a result the sheath is electrically connected in series between each heating element and the conductor encased by the sheath. The sheath may be manufactured from a material which provides a very rapid rise in electrical resistance at a predetermined temperature, thereby enabling the manufacture of a cable which delivers substantially constant power below the predetermined temperature with a rapid reduction in power output at the predetermined temperature.

The present invention relates to an electrical heating cable the power output of which is self limiting as the result of the incorporation of components with a positive temperature coefficient.

Self limiting heating cables are well known. Generally these comprise two conductors extending along the length of the cable and embedded in a polymeric body manufactured from a material providing a positive temperature coefficient. Thus as the temperature of the cable increases the resistance of the material electrically connected between the conductors increases, thereby reducing power output.

Non-self limiting heating cables are known which comprise two power supply conductors extending along the length of the cable and a heating wire which extends along the cable and between the two conductors so as to define a series of heating elements connected in parallel between the conductors. Typically the conductors are enclosed in insulating sheaths and the two sheathed conductors are then encased in a further sheath onto which a heating wire is spirally wound. Portions of the sheaths are cut away so as to enable the heating wire to contact each of the conductors in turn, thereby establishing a series of sections of heating wire which are connected in parallel between the two conductors. Such an arrangement is particularly advantageous as the power output per unit length of the cable can be adjusted simply by adjusting the spacing (in the direction of the length of the cable) between adjacent sections where the sheaths are cut away to enable the heating wire to contact the conductors. Thus with a standard starting component cables delivering different power outputs can be manufactured simply by adjusting the spacing between the portions of the sheaths which are cut away.

U.S. Pat. No. 5,512,732 describes a heating cable which incorporates a spirally wound heating wire which as described above is alternately connected to each of two power conductors. The cable described in U.S. Pat. No. 5,512,732 also provides a self-limiting performance as the result of the incorporation of a thermally actuated switch into the circuit of each of the parallel heating elements defined by the heating wire. A resistive heating element is connected in parallel with each switch so that current passes through the resistive element when the switch is open and current is shunted around the resistive element when the switch is closed. Such an arrangement can provide a self-limiting performance but is difficult to manufacture as compared with non-self limiting heating cable incorporating a spirally wound heating wire.

It is an object of the present invention to provide an improved electrical heating cable.

According to the present invention, there is provided an electrical heating cable comprising at least two power supply conductors extending along the length of the cable and at least one heating element which extends along the cable and between the two conductors, and connected in parallel between the conductors, wherein at least one of the conductors is encased in a sheath of material which has a positive temperature coefficient and the heating element is in electrical contact with the outer surface of the sheath such that the sheath is electrically connected in series between each heating element and the conductor encased by the sheath.

The heating element may comprise a heating wire which extends along the cable and between the two conductors so as to define a series of heating elements connected in parallel between the conductor.

Preferably, the cable comprising a first conductor encased in a first sheath, a second conductor encased in a second sheath manufactured from a material with a positive temperature coefficient, a third sheath encasing a first and second sheath, and a heating wire wound around the first sheath, portions of the third sheath being removed to cause the heating wire to contact the second sheath.

The first sheath may be electrically insulating and in contact with the second sheath, portions of the first and third sheaths being removed to cause the heating wire to contact the first conductor.

The heating element may comprise a semi-conductor.

Embodiments of the present invention will now be described, by way of example, with reference to the accompanying drawings, in which:

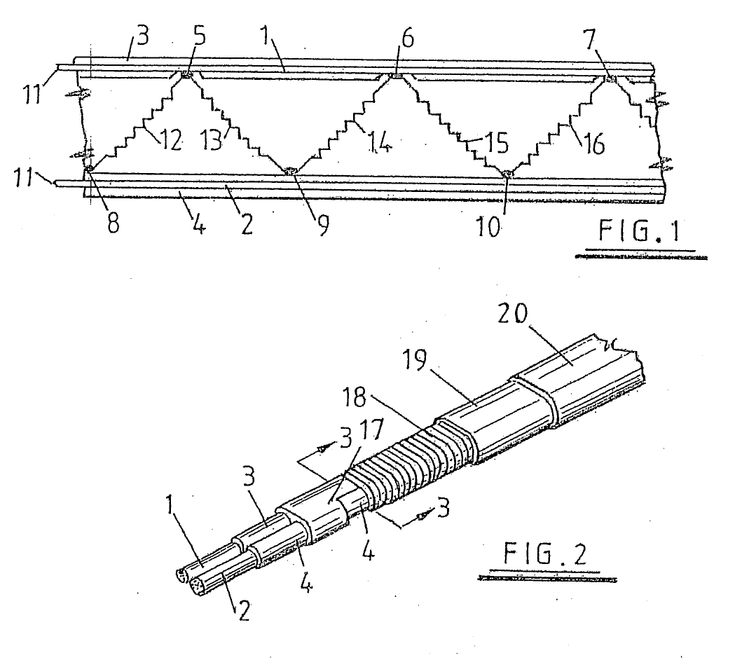

FIG. 1 is a schematic representation of the electrical characteristics of an embodiment of the present invention;

FIG. 2 is a partially cut away perspective view of the embodiment schematically represented in FIG. 1;

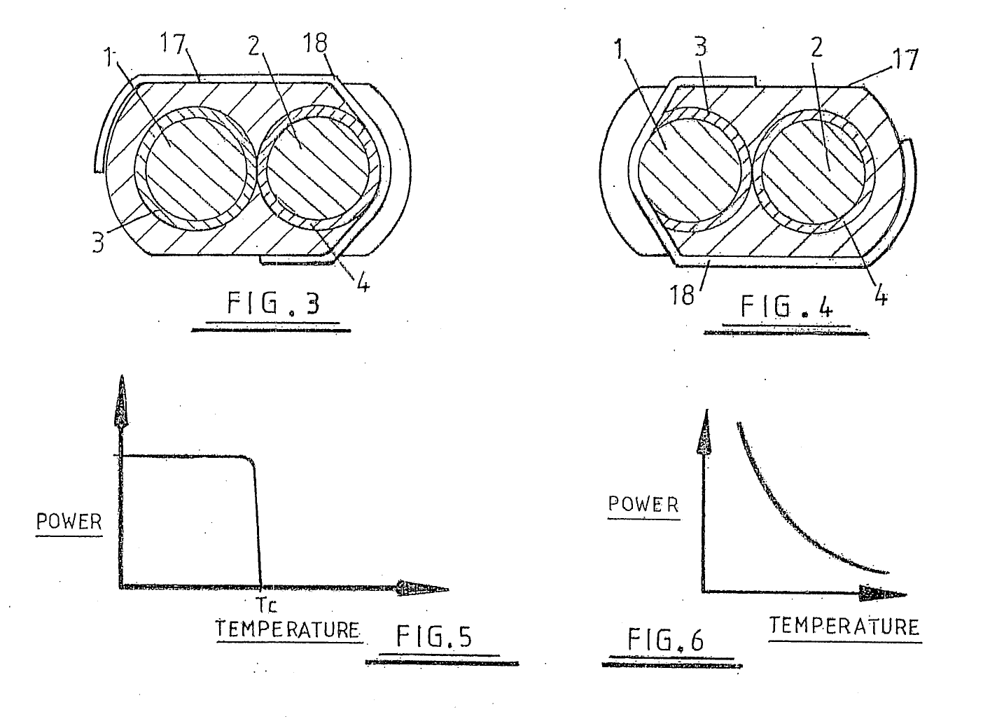

FIG. 3 is a section on the line 3-3 of FIG. 2;

FIG. 4 is a section through the structure illustrated in FIG. 2 at a position spaced from the plane of the section of FIG. 3;

FIG. 5 is a schematic representation of the performance of the embodiment of FIGS. 1 to 3;

FIG. 6 is a schematic representation of the performance of a conventional temperature-limited heating cable; and

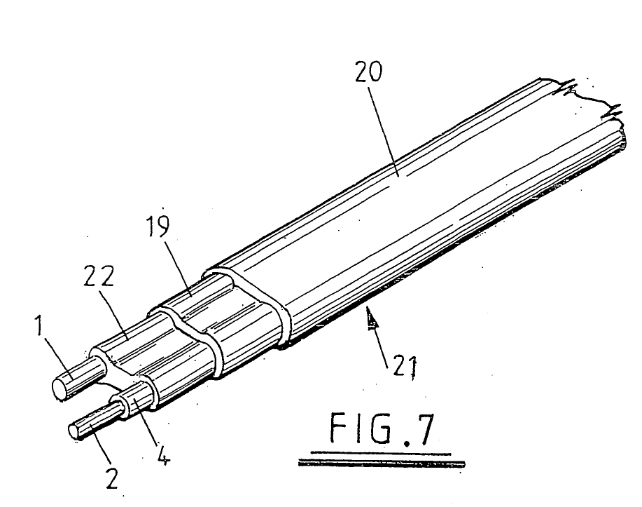

FIG. 7 is a partially cut away perspective view of an alternative embodiment of the present invention.

Referring to FIG. 1, the illustrated heating cable comprises a first copper power supply conductor 1 and a second copper power supply conductor 2. The first conductor 1 is enclosed in an insulating sheath 3 whereas the second conductor 2 is encased in a sheath 4 which incorporates a positive temperature coefficient (PTC) component such that the electrical resistance of the sheath 4 is generally low but rises rapidly as soon as a critical switching temperature is reached. A heating wire makes direct contact with the conductor 1 through openings formed in the sheath 3 at points 5, 6 and 7. The same heating wire makes contact with the outside of the sheath 4 at points 8, 9 and 10. If the ends 11 of the two conductors 1 and 2 are connected to respective terminals of a power supply the heating wire forms five parallel heating zones corresponding to heating wire sections 12, 13, 14, 15 and 16. Each of these sections will generate heat as a function of the voltage applied between terminals 11, the electrical characteristics of the heating wire, and the electrical resistance presented by the sheath 4 to the flow of current between the heating wire and the power supply conductor 2.

Referring to FIG. 2, this shows the structure which results in the characteristics schematically represented in FIG. 1. The sheath 3 and 4 are encased in an insulation jacket 17. In FIG. 2 the heating wire which forms the heating sections 12 to 16 is shown as a spiral of wire 18 spirally wound around the outside of the insulation jacket 17. Portions of the sheath 17 are cut away to enable the wire 18 to contact the outside of the sheath 4 (as shown in FIG. 2) and the conductor 1, the cut away portions being staggered along the length of the cable so that spaced portions of the wire 18 are alternately connected to the conductor 1 and the sheath 4. The heating wire is encased in a further insulation jacket 19 which is received in an outer cover 20.

FIG. 3 is a section on line 3-3 of FIG. 2 and shows how the heating wire 18 is wrapped around the outer surface of the sheath 4 formed around conductor 2. FIG. 4 is an equivalent section through a portion of the cable not shown in FIG. 2 where the sheath 17 and sheath 3 are cut away to enable the heating wire 18 to contact the conductor 1.

As there is direct contact between a number of turns of the heating wire 18 and the conductor 1 there is a substantially zero resistance electrical junction between the conductor 1 and the heating wire 18. In contrast, the heating wire 18 does not make direct contact with the conductor 2 but rather contacts the outer surface of the sheath 4. Thus the sheath 4 is connected electrically in series between the conductor 2 and those turns of the wire 18 which contact the sheath 4. The resistance presented by the sheath 4 is a function of temperature as the sheath 4 incorporates PTC material. Thus, by appropriate selection of the characteristics of the PTC material incorporated in the sheath 4, the relationship between the output power of the heating cable and the temperature of the cable can be accurately controlled.

FIG. 5 is a graph illustrating the relationship between power and temperature assuming that the PTC component incorporated in the sheath 4 is selected such that the electrical resistance provided by the sheath 4 rises very rapidly when a critical temperature Tc is reached. With such a performance the heating cable can be used as a constant power heater. It would be possible to incorporate PTC components in the sheath 4 so as to achieve an output power which declines gradually with temperature and one such characteristic is illustrated in the graph of FIG. 6. Generally the performance represented in FIG. 5 will be preferred.

In the illustrated embodiment, the conductors 1 and 2 may be tin or nickel coated copper having for example nineteen strands of copper each 0.45 mm in diameter to give a cross section for example of approximately 3 square millimetres. The insulation jacket 3 may be of a fluoropolymer such as MA with a thickness of up to 1 mm. The PTC containing coating 4 may be a thermoplastic or fluoropolymer depending on the intended operating temperature. For example a thermoplastic polyethylene could be used in an application where the maximum temperature is intended to be in the region of 80° C. whereas a fluoropolymer may be used when the operating temperature is intended to be up to 150° C. or even up to 260° C. The main ingredient of the sheath 4 providing the PTC performance will generally be carbon black (but could also be carbon fibre or carbon nano-tubes) supplemented with mineral fillers. The characteristics of PTC compounds used in heating cables are widely discussed in the relevant literature and the selection of an appropriate compound will depend upon the final operating characteristics desired.

The heating wire 18 may be nickel chromium and the insulation and outer jackets 19 and 20 may be of MEA. The wattage per unit length of the cable will be determined by the spacing between the regions at which the heating wire 18 contacts alternately the conductor 1 and the PTC jacket 4. Thus a standard product can be produced up to and including the jacket 17. Portions of the jacket 17 may then be removed with the spacing between adjacent portions being determined by the desired final electrical characteristics. The heating wire 18 can then be wound onto the cable and covered by the insulation jacket 19 and outer jacket 20.

A thermally conductive material in for example paste or spray-on form may be applied to the exposed portions of the conductor 1 and jacket 4 to improve electrical contact with the subsequently wound heating wire 18 and to reduce the risk of damage to the PTC jacket 4.

It will be appreciated that embodiments of the invention may take any number of forms. For instance, FIG. 7 illustrate an electrical heating cable 21 in accordance with an alternative embodiment of the present invention. The heating cable 21 comprises a first power supply conductor 1 and a second power supply conductor 2. The conductor 2 is encased in a sheath 4 which incorporates a PTC component such that the electrical resistance of the sheath 4 is generally low but rises rapidly as soon a critical switching temperature is reached. In this embodiment, conductor 1 is not encased in an insulating sheath. The heating element comprises a semi-conductor extending between, and electrically connected to, the two conductors 1, 2. The semi-conductor 22 makes electrical contact with conductor 2 via sheath 4. In this particular embodiment, the semi-conductor 22 takes the form of a polymeric matrix body, in which the two conductors are embedded.

In this particular embodiment, it is envisaged that the semi-conductor 22 is constant wattage i.e: it has no appreciable change in resistance with temperature. Consequently, by appropriate selection of the PTC of the sheath 4, the performance of the heating cable 21 can be arranged to be generally similar to that of the other embodiment i.e. similar to that shown in FIG. 5.

In the described embodiments of the invention only one of the two conductors 1, 2 is encased in a PTC sheath. It would be possible to enclose both conductors in a PTC sheath so that each section of the heating wire is connected in series with two PTC sheaths either of which would be sufficient to provide the necessary self-limiting performance. In such an arrangement it would of course be necessary to ensure that the two PTC sheaths were separated to avoid a short-circuit.

Equally, in the above embodiment, it has been assumed that the heating element (i.e. the heating wire or the semi-conductor) is generally constant wattage. However, it will be appreciated that the heating element can be formed of a material having a positive or a negative temperature coefficient. For instance, by providing a sheath 4 having a positive temperature coefficient, and a heating element 22 having a different positive temperature coefficient, a cable can be produced that is self-regulating up to a predetermined temperature, at which it self-limits.

1. An electrical heating cable comprising at least two power supply conductors extending along the length of the cable and at least one heating element which extends along the cable and between the two conductors, and connected in parallel between the conductors, wherein at least one of the conductors is encased in a sheath of material which has a positive temperature coefficient and the heating element is in electrical contact with the outer surface of the sheath such that the sheath is electrically connected in series between each heating element and the conductor encased by the sheath.

2. An electrical heating cable according to claim 1, wherein said heating element comprises a heating wire which extends along the cable and between the two conductors so as to define a series of heating elements connected in parallel between the conductor.

3. An electrical heating cable according to claim 2, comprising a first conductor encased in a first sheath, a second conductor encased in a second sheath manufactured from a material with a positive temperature coefficient, a third sheath encasing the first and second sheaths, and a heating wire round around the third sheath, portions of the third sheath being removed to cause the heating wire to contact the second sheath.

4. An electrical heating cable according to claim 3, wherein the first sheath is electrically insulating and is in contact with the second sheath, portions of the first and third sheaths being removed to cause the heating wire to contact the first conductor.

5. An electrical heating cable according to claim 1, wherein the heating element comprises a semi-conductor.

6. An electrical heating cable substantially as hereinbefore described with reference to the accompanying drawings
